(19) United States
(12) Patent Application Publication
(10) Pub. No.: US 2009/0294271 A1
(43) Pub. Date: Dec. 3, 2009

(54) Device for Purification of a Liquid

(75) Inventors: Peter Holmberg, Ramsjo (SE); Aapo Saask, Stockholm (SE)

Correspondence Address: FROST BROWN TODD, LLC, 2200 PNC CENTER, 201 E. FIFTH STREET, CINCINNATI, OH, 45202, US

(73) Assignee: Purity AB, Stockholm (SE)

(21) Appl. No.: 12/374,425

(22) PCT Filed: Jul. 19, 2007
(86) PCT No.: PCT/SE07/50531

§ 371 Date: Jan. 20, 2009

(30) Foreign Application Priority Data
Jul. 20, 2006 (SE) 0601592-9

(51) Int. Cl. B01D 3/42

(52) U.S. Cl. 202/206

(57) ABSTRACT

The present invention refers to a device (1) for cleaning fluid from contaminating matter, which device comprises a vessel (11) for fluid, a heating element (12) for heating fluid, control electronics (13) to control the heating element (12), and also a temperature sensor (14) for measuring the temperature of the fluid. The control electronics (13) is adapted to lower the heating capacity of the heating element (12) when the fluid has reached a predetermined temperature according to temperature sensor (14) and thereafter let the fluid be heated by a lower effect during a predetermined time period according to a time measuring unit (15) belonging to the device. This time measuring unit (15) comprises a frequency counting unit (15a), adapted to count periods in the supply current (16) input to the device (1). The time measuring unit (15) indicates to the control electronics (13) that the time period has elapsed when the number of counted periods corresponds to the time period in seconds times the frequency for the incoming supply current (16).

### TECHNICAL FIELD

The present invention relates to a device for cleaning fluid from contaminating matter. The device comprises a vessel for fluid, a heating element for heating fluid contained in the vessel, control electronics to control the heating element, and also a temperature sensor for measuring the temperature of fluid contained in the vessel.

The control electronics is adapted to lower the heating capacity of the heating element when the fluid contained in the vessel has reached a predetermined temperature according to the temperature sensor and thereafter let the fluid be heated by a lower effect during a predetermined time period according to a time measuring unit belonging to the device

The present invention also relates to a temperature sensor whereby a temperature for a fluid contained in the vessel can be measured.

The present invention also relates to a lid intended to close the vessel, where there is in connection to the lid arranged a breaking element intended to allow a break of the supply voltage to the heating element if the lid does not close the vessel

### BACKGROUND ART

It is known to allow for example a thermopot to heat water to the boiling point and thereafter let the water boil during a predetermined time period with the intention of cleaning the water from different kinds of contamination, this requires a way of measuring time.

It is known to use a microprocessor in a circuit arrangements whereby different heating processes can be programmed and controlled through this microprocessor.

The patent publication GB 2 298 723 discloses an arrangement with a square wave generator that generates a square wave that is used as a time reference by a microprocessor, which controls the heating- and boiling process. The microprocessor can be programmed to control different heating processes. It should also be mentioned that it is known to use breakers of bimetal, which at a certain temperature achieves a mechanical movement that breaks the supply current at the desired temperature, or indicates that a certain temperature has been reached so that the control electronics can take desired actions at the reached temperature.

It is known that devices intended for boiling fluid, as water boiling thermopots, have a safety switch in the lid that prohibits the boiling process to be started if the lid is not closed and that discontinues the boiling process if the lid is opened during the process.

According to known art mechanical switches or breakers are used, but as these must withstand high effects or currents, large components are required that should be installed in a very limited space. These components are in addition expensive, as they must resist the damp and hot environment a water boiling thermopot constitutes.

There are high demands on a breaker for example in a water boiling thermopot as the security for the user would be very low if the breaker did not work properly. It is to make shure that a user does not become exposed to hot water, so if the lid does not close the vessel in an satisfactory way, which could constitute a danger for a user, an ongoing boiling process should be terminated and a new boiling process should not be possible to begin before the lid closes the vessel.

It is also know to allow water to afterboil a certain time after that the water has started boiling, in which case the security requirements are even more important as the boiling water has a high temperature and the effect supply to the water immediately has to be interrupted in the case that the lid does not close the vessel. Long boiling times also provides an even damper and hotter environment for the safety switch.

### SUMMARY OF THE INVENTION

### Technical Problems

To produce a device for cleaning of fluid that works in a safe and appropriate way, a number of more or less complex components and an interaction between these are required. Time and temperature has to be measured and the device has to be safe during the heating process and the subsequent afterheating. Included components are to work in a difficult environment with high temperatures and high humidity. The components should preferably be so simple and cheap as possible so that the device can be sold on a consumer market for private persons.

It is a technical problem to measure time in a simple and cost-effective way and in that this way adjust how long the heating element should heat the fluid after the fluid has started boiling.

Microprocessors and the additional equipment that are required to adjust a heating process of a fluid are expensive and complex, it is consequently a technical problem to be able to provide a cheaper and simpler, but still working, solution to the time measuring function.

It can also be mentioned that bimetal breakers are mechanical constructions with a limited working life that requires steam to be conducted from the boiling fluid to the bimetal, which in its turn will create problems with condensation and high temperature for other parts in the device.

It is also a technical problem to provide a breaker in a device designated to heat fluid, which breaker must withstand the environment with aqueous steam and high temperatures that prevail in such a device.

It is a technical problem to provide a small beaker to a low price and that can adjust the device effect or currents needed to run the heating elements in a device intended to heat fluid.

### Solution

The present invention refers to solving one or more of the aforementioned problems by letting the time measuring unit comprise a frequency counting unit, adapted to count periods in the incoming supply current of the device, which time measuring unit indicates to the control electronics that the time period has elapsed when the number of counted cycles is equivalent to the time period in seconds times the frequency of the supply current.

The present invention teaches that the predetermined time period is adjustable by the control electronics and the time measuring unit.

The lower effect is sufficient to maintain fluid contained in the vessel at its boiling point during said predetermined time period.

For example, the heating element can output an effect of 2 200 W until the predetermined temperature is reached, and it can output an effect of 450 W during the predetermined time period.

This is possible by for example letting the heating element comprise two heating elements, a first element that can output an effect of 1750 W and a second element that can output an effect of 450 W. The control electronics can be adapted to let both the first and second element operate until the predetermined temperature is reached, and let only the second element operate during said predetermined time period.

With the intention of providing a simple and to the largest extent possible a passive solution on the adjustment of the heating process, the present invention teaches that the temperature sensor is located with at least one surface facing into the vessel, and that a fluid insulating layer insulates the temperature sensor from fluid contained in the vessel, that the temperature sensor consists of a sensor which electric characteristics are dependent of the temperature, that the control electronics is adapted to read these electric properties and therefrom read the temperature.

The temperature sensor can consist of a thermoelement or a resistive circuit, such as a Pt100-sensor.

The predetermined temperature is adjustable by way of the control electronics, and if the intention is that the fluid should reach its boiling point this predetermined temperature corresponds to the boiling point of the fluid.

The present invention teaches that if the device is adapted to cleaning of water, that said predetermined temperature is 100° C., and that predetermined time period corresponds to 180 seconds.

The present invention also teaches that a device where the breaking element consists of a first component and a second component which together forms a magnetic breaker.

The first component and second component respectively are encased and thereby protected against moisture, which enables the components to withstand the difficult environment that prevail for example in a water boiling thermopot.

The first component is mounted in the lid, and the second component is mounted in the device in a position so that the breaker assumes a closed or an open state depending on if the lid closes the vessel or not.

The components are preferably placed so that the first component is close to the second component when the lid closes the vessel and so that the distance between the components increases when the lid does not close the vessel.

The present invention teaches that control electronics of the device is arranged to detect the position of the breaker, and that the control electronics is adapted to break the supply voltage in a position for the breaker which indicates that the lid does not close the vessel.

This is possible by letting the control electronics comprise a relay, which is adapted to break or connect the supply voltage and is adapted to break or connect the effects or currents that are required for operating a heating element, where the breaker is connected to the relay so that the relay breaks the supply voltage when the lid does not close the vessel or connects the supply voltage when the lid is closed.

An example of a first and second element is a permanent magnet and a Hall-element respectively.

### Advantages

The advantages of using a counter of the frequency that is prevailing in the supply voltage for measuring the time is that no frequency need to be generated in the device. Frequency counting circuits are simple and cheap and can be combined with the control electronics to be able to measure with high accuracy and reliability the time that the afterheating should continue.

The present invention offers a good control of a heating process with afterheating without the need of a microprocessor and thus with no need of programming such a microprocessor.

The frequency of the supply voltage is stable and always available.

Furthermore, the combination with an electric temperature sensor offers high reliability and accuracy as well as a long lifespan compared with mechanical breakers with bimetal.

The advantages by using a magnetic breaker to control that the lid is closing the vessel is that such a breaker is reliable in service, it can be wholly encased without movable parts that does that it will not be affected by heat or moisture, and it has a long technical lifespan.

### BRIEF DESCRIPTION OF THE DRAWINGS

A device with the features associated to the present invention will now be described more closely in an exemplifying purpose with reference to the accompanying drawings where:

FIG. 1 schematically illustrates a device according to the invention,

FIG. 2 schematically shows an encased temperature sensor,

FIG. 3 schematically shows a device with a lid that closes the vessel,

FIG. 4 schematically shows a device with a lid that not completely closes the vessel,

FIG. 5 schematically shows a device with a lid that is fully open,

FIG. 6 schematically shows an alternative location of the components belonging to the breaker with a lid that closes the vessel,

FIG. 7 schematically shows an alternative location of the components belonging to the breaker with a lid that not completely closes the vessel,

FIG. 8 schematically shows an alternative location of the components belonging to the breaker with a lid that is fully open.

### DETAILED DESCRIPTION OF PROPOSED EMBODIMENTS

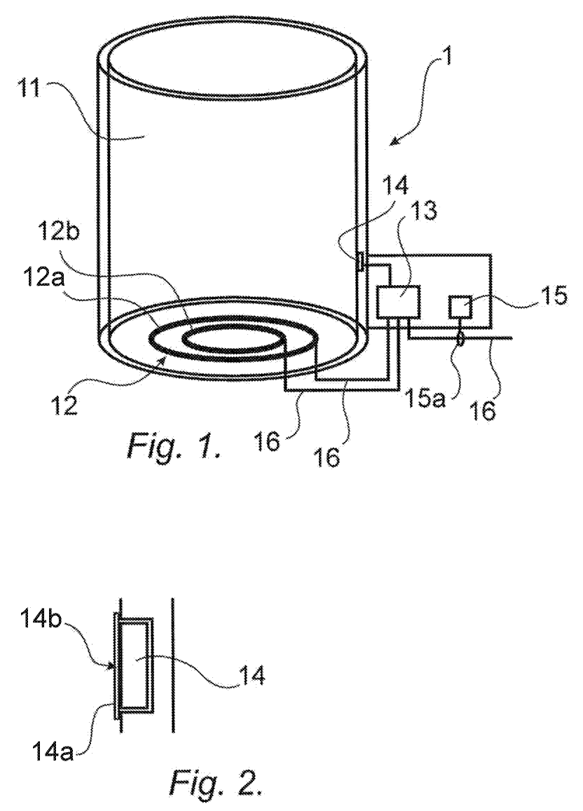

With reference to FIG. 1 a device 1 is shown for cleaning fluid from contaminating matter, which device comprises a vessel 11 for fluid, a heating element 12 for heating fluid contained in the vessel, control electronics 13 to control the heating element 12, and also a temperature sensor 14 for measuring the temperature of fluid contained in said vessel 11.

The control electronics 13 is adapted to lower the heating capacity of the heating element 12 when the fluid contained in the vessel has reached a predetermined temperature according to temperature sensor 14 and thereafter let fluid be heated by a lower effect during a predetermined time period dt according to a time measuring unit 15 belonging to device 1

The present invention teaches that the time measuring unit 15 comprises a frequency counting unit 15a, adapted to count periods in the input supply current 16 to the device 1.

The time measuring unit 15 indicates to the control electronics 13 that the time period has elapsed when the number of counted periods “n” corresponds to the time period “dt” in seconds times the frequency “f” for the incoming supply current 16, according to the formula

n=dt·f

If the desired time period “dt” is 180 seconds, and if the frequency for the supply current “f” is 50 Hz, the number of periods “n” which should be counted accordingly:

n=180·50=9000

Accordingly, in this very easy way a desired time period can be measured and time measuring unit 15 can indicate to the control electronics 13 that the time period of 3 minutes, or 180 seconds, has elapsed when these 9000 periods have is been counted if the supply current has a frequency of 50 Hz.

This also makes it easy to let the predetermined time period “dt” be adjustable by the control electronics 13 and the time measuring unit 15.

The integrated circuit SN8P2501A from the manufacturer Sonix is an example of an available circuit that could act as a frequency-ounting unit according to the present invention. This circuit could be adjusted so that it starts counting after a start signal from the supply current 13, which should be done when the desired temperature is reached, and so that it returns a signal to the control electronics 13 when the number of periods “n” has been counted, which according to the example above would be 9000. Accordingly the device can easily be adapted to different time periods “dt” and different frequencies “f” of the supply current 16.

The present invention teaches that the lower effect is enough to maintain a in the vessel 11 enclosed fluid at its boiling point during the predetermined time period “dt”.

For example, the heating element 12 can leave an effect of 2 200 W until that the predetermined time period is reached, after which the heating device leaves an effect of 450 W during the predetermined time period “dt”.

This can easily be achieved by letting the heating element 12 comprise two heating elements 12a, 12b where the first element 12a can output an effect of 1750 W and the second element can output an effect of 450 W. In this example the control electronics 13 is adapted to let both the first and second element 12a, 12b operate until the desired temperature is reached, and the control electronics is adapted to let only the second element 12b operate during the predetermined time period “dt”.

With the intention to provide a good measurement of the temperature the present invention teaches that the temperature sensor 14 is located with at least one surface facing into the vessel 11, which is schematically shown in FIG. 2. A fluid insulating layer 14b insulates the temperature sensor 14 from fluid contained in the vessel 11. The temperature sensor 14 consists advantageously of a sensor with electric characteristics that are dependent of the temperature, and the control electronics 13 is adapted to read these electric properties and therefrom read the temperature.

Examples of such temperature sensors are thermal elements and resistive sensors, such as a Pt100-sensor.

Depending on which type of sensor is used, and how the change in temperature is indicated by the sensor, the predetermined temperature can be adjusted by way of the control electronics 13, and if it is desirable that the fluid should reach its boiling point, the predetermined temperature is set so that it corresponds to the boiling point of the fluid.

A device according to the invention could be adapted to cleaning of water, in which case the predetermined temperature is 100° C., and that predetermined time period “dt” corresponds to 180 seconds.

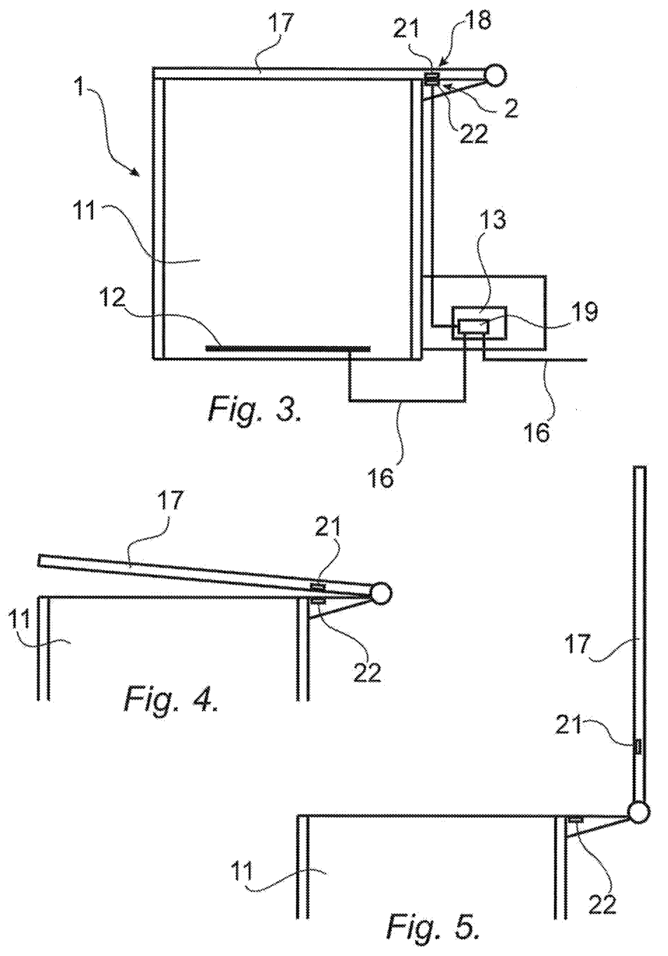

With reference to FIG. 3 a device 1 is shown which comprises a lid 17 intended to close the vessel 11 during heating of the fluid contained in the vessel, a heating element 12 for heating the fluid contained in the vessel, control electronics 13 for control of the heating element 12, and also a in connection to the lid arranged breaking element 18 intended to allow a break of the supply voltage 16 to the heating element 12 if the lid 17 does not close the vessel 11.

The present invention teaches that the breaking element 18 consists of a first component 21 and a second component 22 which together forms a magnetic breaker where the first component and second component 21, 22 respectively are encased and thereby protected against moisture.

It is suggested that the first component 21 is mounted in the lid 17, that the second component 22 is mounted in the device 1 in a position so that the breaker 2 assumes a closed or an open state depending on if the lid 17 closes the vessel 11 or not.

FIG. 3 shows that the first component 21 is close the second component 22 when the lid 17 closes the vessel.

FIG. 4 shows that the distance between the first and second component 21, 22 increases when the lid 17 does not close the vessel 11 and FIG. 5 shows the lid 17 in a fully open position, which results in that the first component is at a long distance from the second component 22. A magnetic breaker operate so that if the mutual distance between the components 21, 22 becomes to large, the breaker 2 takes an open state, but if the mutual distance is small enough the breaker 2 takes an closed state. How large the distance for change of state is depends on which type of breaker that is used and it is obvious for the person skilled in the art that respective component 21, 22 can be placed in relation to each other in a way that the closed state for breaker 2 only occurs when the lid 17 closes the vessel 11 and so that a slightly incorrect position of the lid 17 in relation to the vessel 11 results in that the open state for the breaker 2 occurs.

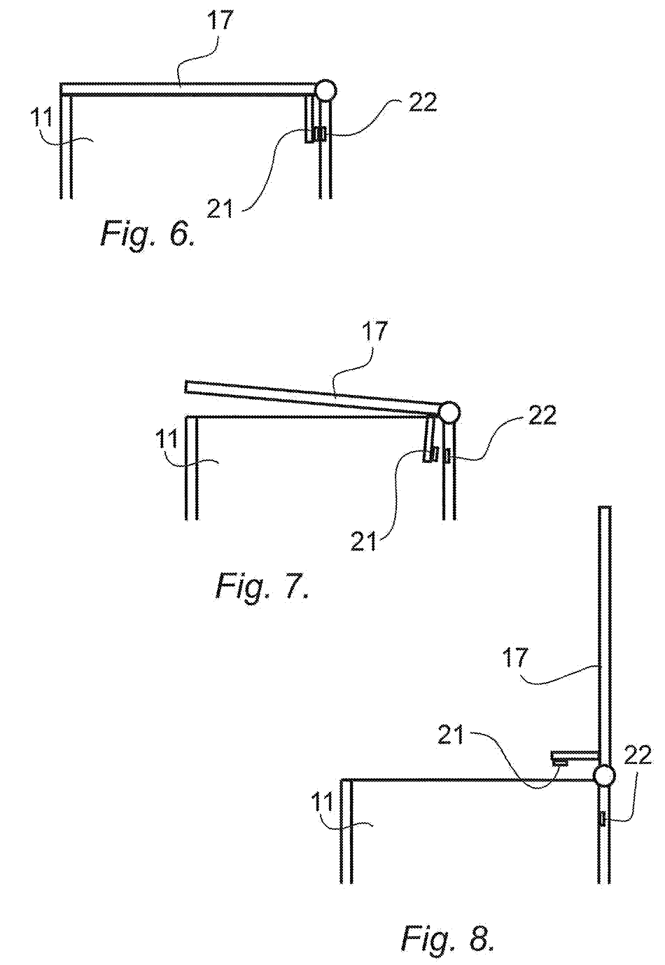

FIGS. 6, 7 and 8 shows schematically a possible location of the components 21, 22 in a device according to the invention. It shall be understood that the invention is not limited to this placement but that the inventive thought is that the lids 17 position in relation to the vessel 11 affects the mutual distance between the two components 21, 22. the FIGS. 4, 4 and 6 shows another possible placement of the components 21, 22 that also fall within the scope of the inventive thought.

The present invention teaches that the control electronics 13 is arranged to sense the position of the breaker 2, and that the control electronics 13 is arranged to break the supply voltage 16 in a position of the breaker 2 that indicates that the lid does not close the vessel 11.

This is possible by for example allowing the control electronics 13 to comprise a relay 19, which is adapted to break or connect the supply voltage 16.

Thus the breaker can be connected to the relay 19 so that the relay 19 breaks the supply current 16 when the lid 17 does not close the vessel 11 and that the relay 19 connects the supply voltage 16 when the lid 17 does close the vessel 11.

As an example of magnetic breakers 2 the presents invention teaches that the first and second components 21, 22 can consist of a permanent magnet and a Hall-element.

The invention is naturally not restricted to the as example above mentioned embodiments but can undergo modifications within the scope of the inventive thought as it is shown in the following claims.

1. A device for cleaning fluid from contaminating matter, said device comprising a vessel for fluid, a heating element for heating fluid contained in said vessel, control electronics to control said heating element, and also a temperature sensor for measuring the temperature of fluid contained in said vessel, in which said control electronics is adapted to lower the heating capacity of the said heating element when a fluid contained in said vessel has reached a predetermined temperature according to said temperature sensor and thereafter let said fluid be heated by a lower effect during a predetermined time period according to a time measuring unit belonging to said device, characterized in that the time measuring unit comprises a frequency counting unit, adapted to count cycles of the supply current to said device, that said time measuring unit indicates to said control electronics that said time period has elapsed when the number of counted cycles is equivalent to said time period in seconds times the frequency of said supply current, that said predetermined time period is adjustable by said control electronics and said time measuring unit, that said temperature sensor is located with at least one surface facing into said vessel, and that a fluid insulating layer insulates said temperature sensor from fluid contained in said vessel, that said temperature sensor consists of a sensor which electric characteristics are dependent of the temperature, that said control electronics is adapted to read said electric properties and therefrom read said temperature, and that said device comprises a lid intended to close said vessel during heating of the fluid contained in said vessel, and also a connection to said lid arranged breaking element intended to allow a break of the supply voltage to said heating element if said lid does not close said vessel, that said breaking element consists of a first component and a second component which together forms a magnetic breaker, that the first component and second component respectively are encased and thereby protected against moisture, that the first component is mounted in said lid, that said second component is mounted in said device in a position so that said breaker assumes a closed or an open state depending on if said lid closes said vessel or not.

2. A device according to claim 1, characterized in that said lower effect is sufficient to maintain fluid contained in said vessel at its boiling point during said predetermined time period.

3. A device according to claim 1, characterized in that said heating element outputs an effect of 2 200 W until that said predetermined temperature is reached, and that said heating element outputs an effect of 450 W during said predetermined time period.

4. A device according to claim 3, characterized in that said heating element comprises two heating elements, that a first element can output an effect of 1750 W, that a second element can output an effect of 450 W, that said control electronics is adapted to let both the first and second element operate until said predetermined temperature is reached, and that said control electronics is is adapted to only let said second element operate during said predetermined time period.

5. A device according to claim 1, characterized in that said temperature sensor consists of a thermal element.

6. A device according to claim 5, characterized in that said temperature sensor consists of a resistive sensor.

7. A device according to claim 5, characterised in that said predetermined temperature is adjustable by way of said control electronics.

8. A device according to claim 1, characterized in that said first component is close to said second component when said lid closes said vessel and so that the distance between said components increases when said lid does not close said vessel.

9. A device according to claim 8, characterized in that said control electronics is arranged to detect the position of said breaker, and that said control electronics is adapted to break said supply voltage in a position for said breaker which indicates that said lid does not close said vessel.

10. A device according to claim 9, characterized in that said control electronics comprises a relay, which is adapted to break or connect said supply voltage, and that said breaker is connected to said relay so that said relay breaks said supply voltage when said lid does not close said vessel or connecting said supply voltage when said lid is closed.

11. A device according to claim 8, characterized in that said first and second component consists of a permanent magnet respectively a Hall-element.

12. A device according to claim 1, characterized in that said predetermined temperature corresponds to the boiling point of said fluid.

13. A device according to claim 1, characterized in that said device is adapted to the cleaning of water, that said predetermined temperature is 100° C., and that said predetermined time period corresponds to 180 seconds.
